(19) United States
(12) Patent Application Publication
(10) Pub. No.: US 2007/0234073 A1
(43) Pub. Date: Oct. 4, 2007

(54) Random password automatically generated by bios for securing a data storage device

(75) Inventors: Daryl Cromer, Cary, NC (US); Howard J. Locker, Cary, NC (US); Randall S. Springfield, Chapel Hill, NC (US); Rod D. Waltermann, Rougemont, NC (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: Lenovo (Singapore) Pte. Ltd., Singapore (SG)

(21) Appl. No.: 11/396,267

(22) Filed: Mar. 31, 2006

(51) Int. Cl. G06F 12/14

(52) U.S. Cl. 713/193

(57) ABSTRACT

A system, method, and computer readable medium are disclosed. The method includes automatically generating a set of security data. The security data is stored in non-volatile memory. The set of security data is also programmed into the data storage device as a security code.

### FIELD OF THE INVENTION

The present invention generally relates to the field of information processing systems, and more particularly relates to securing a data storage device within an information processing system.

### BACKGROUND OF THE INVENTION

Computer systems have become widely available to the general public in recent years. This increase in availability is mainly attributed to lower costs associated with manufacturing the components of the computer systems. However, in many instances, a consumer or a business may not have enough capital to purchase a computer or only needs the computer for a short period of time. In these situations, renting a computer is an attractive option. Instead of paying a large amount of money for a computer and software, a user pays by the month or by usage.

However, in some instances, the rental model is abused by the user. For instance, a user can easily dismantle the rental computer and sell the components of the system. One component of the rental computer that is in high demand is the hard-drive. The hard-drive includes valuable, information, software, and the like. The hard-drive can be taken out the rental computer system giving the user a free operating system, software, and the like.

Currently, hard-drives have the ability to be password protected. This ability is utilized by security systems, which try and protect hard-drives from unauthorized use. However, the user of the computer system is the one who chooses the password and/or at least has access to the password. For a rental computer, the hard-drive is still useable after it is detached from the rental computer.

Therefore a need exists to overcome the problems with the prior art as discussed above.

### SUMMARY OF THE INVENTION

In one embodiment of the present invention a method is disclosed. The method includes automatically generating a set of security data. The security data is stored in non-volatile memory. The set of security data is also programmed into the data storage device as a security code.

In another embodiment of the present invention an information processing system is disclosed. The information processing system comprises a motherboard and a security data generator. The security data generator is communicatively coupled to the motherboard and automatically generates at least one set of security data. The information processing system also includes at least one data storage device that is communicatively coupled to the motherboard. The data storage device requires a programmed security code to access data stored therein. The security data generator programs a security code associated with the set of security data into the at least one data storage device as a programmed security code.

In yet another embodiment of the present invention, a computer readable medium is disclosed. The computer readable medium includes instructions for automatically generating a set of security data. The security data is stored in non-volatile memory. The set of security data is also programmed into the data storage device as a security code.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram of an information processing system, according to an embodiment of the present invention;

FIG. 2 is an operational flow diagram illustrating an exemplary process of automatically generating a password for a data storage device in response to the information processing system of FIG. 1 booting up for the first time, according to an embodiment of the present invention; and

FIG. 3 is an operational flow diagram illustrating an exemplary process of authenticating a data storage device using an automatically generated password, according to an embodiment of the present invention.

### DETAILED DESCRIPTION

The present invention as would be known to one of ordinary skill in the art could be produced in hardware or software, or in a combination of hardware and software. However in one embodiment the invention is implemented in software. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium, which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network that allows a computer to read such computer readable information. The present invention, according to an embodiment, overcomes problems with the prior art by providing a more efficient mechanism for memory copy operations. The present invention allows the processor to continue executing subsequent instructions during a memory copy operation thereby avoiding unnecessary processor downtime.

Exemplary Information Processing System

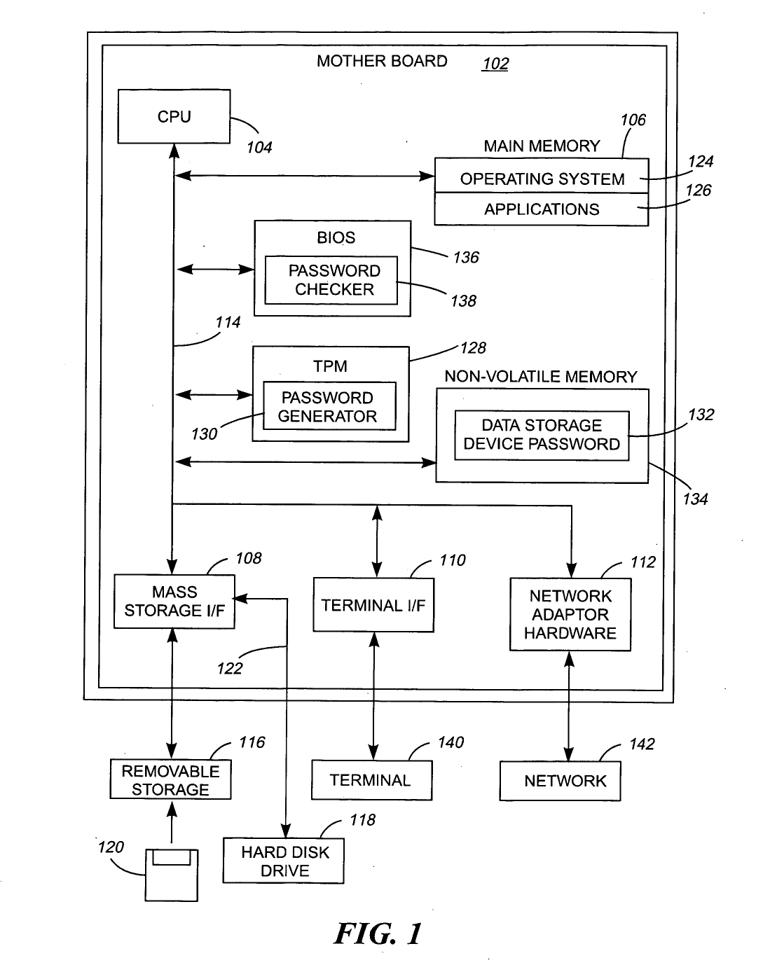

FIG. 1 is a block diagram illustrating a detailed view of an information processing system 100 according to an embodiment of the present invention. The information processing system 100 is based upon a suitably configured processing system adapted to implement the exemplary embodiment of the present invention. Any suitably configured processing system is similarly able to be used as the information processing system 100 by embodiments of the present invention, for example, a personal computer, workstation, notebook computers, handheld computer, personal digital assistants (“PDAs”), wireless smartphone, or the like. In one embodiment, the information processing system 100 is a rental system. A rental system is herein defined as any information processing system that is provided to a user for a specific period of time in exchange for a fee, wherein the rental system is returned back to the provider after such time period has expired.

The information processing system 100 includes a motherboard 102. The mother board 102 has a processor 104 that is connected to a main memory 106 such as Random Access Memory (“RAM”), mass storage interface 108, terminal interface 110, and network adapter hardware 112. A system bus 114 interconnects these system components. Although only one processor 104 is illustrated for the motherboard 102, computer systems with multiple processors can be used equally effectively. Embodiments of the present invention further incorporate interfaces that each includes separate, fully programmed microprocessors that are used to off-load processing from the processor 104.

Terminal interface 110 is used to directly connect one or more terminals 140 to the motherboard 102 to provide a user interface to the motherboard 102. These terminals 140, which are able to be non-intelligent or fully programmable workstations, are used to allow system administrators and users to communicate with the information processing system 100. The terminal 140 is also able to consist of user interface and peripheral devices that are connected to motherboard 102 and controlled by terminal interface hardware included in the terminal I/F 110 that includes video adapters and interfaces for keyboards, pointing devices, and the like.

The network adapter hardware 112 is used to provide an interface to a network 142. Embodiments of the present invention are able to be adapted to work with any data communications connections including present day analog and/or digital techniques or via a future networking mechanism. The mass storage interface 108 is used to connect mass storage devices, such as a removable storage device 116 and a hard disk drive 118 to the information processing system 100 information. The mass storage interface 108, in one embodiment, is an Advanced Technology Attachment (“ATA”) controller. One specific type of removable storage device is a computer readable medium such as a floppy disk drive, which may be used to store data to and read data from a floppy diskette 120 or CD (not shown). Another type of data storage device is a data storage device configured to support, for example, NTFS type file system operations such as the hard disk drive 118. In one embodiment, the hard disk drive 118 is communicatively coupled to the motherboard 102 by integrated device electronics/advanced technology attachment packet interface (“IDE/ATAPI”) bus 122. It should be understood that other types of drives such as floppy drives, magnetic tape drives, optical drives, flash drives, and the like may also be used within the scope of the present invention.

The main memory 106 comprises an operating system 124 and applications 126. The operating system 124, in one embodiment, is a suitable multitasking operating system such as the Linux, UNIX, Windows XP, and Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor 104 located within the information processing system 100. The application(s) 126, for example, is executing or waiting to be executed within the main memory 106.

Although illustrated as concurrently resident in the main memory 106, it is clear that respective components of the main memory 106 are not required to be completely resident in the main memory 106 at all times or even at the same time. In one embodiment, the information processing system 100 utilizes conventional virtual addressing mechanisms to allow programs to behave as if they have access to a large, single storage entity, referred to herein as a computer system memory, instead of access to multiple, smaller storage entities such as the main memory 106, removable storage device 116, and hard disk drive 118. Note that the term “computer system memory” is used herein to generically refer to the entire virtual memory of the information processing system 100.

The motherboard 102 also includes a trusted platform module (“TPM”) 128. The TPM 128, in one embodiment, automatically generates security data such as a password 132 for securing a data storage device such as the hard disk drive 118. The password 132 is automatically generated without any interaction from a user of the information processing system 100. In one embodiment, the TPM 128 comprises a password generator 130 such as a random key generator for generating the password 132. For illustrative purposes only, the remaining discussion refers to the security data generated by the TPM 128 as a password. It should be noted that using a TPM 128 is only one example of generating security data. Alternative embodiments of the present invention generate the hard drive password 132 in, for example, the CPU 104, or in an external test fixture (not show) that is connected to the bus 114 during manufacturing and/or test. A TPM 128 allows for a more secure environment when generating security data. In another embodiment, a random number generator is used without the TPM 128 to generate security data. It should be appreciated by those of ordinary skill in the art that any mechanism for generating security data can be used within the scope of the present invention.

The password 132, in one embodiment, is automatically generated during the manufacturing process of the information processing system 100. For example, during the configuration stage of manufacturing, the information processing system 100 is booted for the first time. A basic input/output system (“BIOS”) 136, which includes a password checker 138 in one embodiment, determines if a hard drive password 132 has been stored. An exemplary embodiment of the present invention stores the hard drive password 132 with a checksum value that is checked to determine if a valid hard drive password 132 has been stored. Further embodiments may include a flag as an indication of the presence of a valid hard drive password. Because this is the first time the system 100 has been initialized, a hard drive password 132 does not exist. In response to the determination that a valid hard drive password does not exist, the BIOS 136 randomly defines a hard drive password 132 via the TPM 128 and stores the hard drive password 132, in one embodiment, in non-volatile memory 134 on the motherboard 102. The non-volatile memory 134 can reside within the TPM 128 or outside of the TPM 128. Hard drive passwords are able to be stored as an encrypted representation using either within the TPM 128 or outside the TPM 128, for example, open key encryption techniques as are known to ordinary practitioners in light of the present discussion. In one embodiment, the TPM 128 uses a private key to encrypt the hard drive password. Therefore, if the system 100 is compromised and an unauthorized source locates the hard drive password, the contents of the password are indiscernible because of the encryption.

Once the hard drive password 132 is generated, the hard drive password 132 is programmed into the hard drive 118. For example, the hard drive password 132 is stored in the firmware of the hard drive 118 by using an ATA interface command. The hard drive password can be programmed into the hard drive 118 either in an encrypted state or in a decrypted state. For example, the hard drive password can be received by the hard drive 118 either in an encrypted state or decrypted state. If the hard drive password is received in an encrypted state, further encryption can be performed or the password can be decrypted and stored in a decrypted state. Alternatively, if the hard drive password is received in an decrypted state, the password can be encrypted. The hard drive password 132 is encrypted using any encryption technique as would be well known to one of ordinary skill in the art in light of the present discussion.

Various embodiments of the present invention store, program and then subsequently transmit the password, or security data, in different encrypted states. For example, some embodiments store the password in an encrypted state and then retrieves and decrypts the stored, password in order to send the decrypted password to the hard drive to after initialization to authorize access to the drive. Other embodiments store the randomly defined password in an unencrypted state and then encrypt the password to produce the security data that is programmed into the hard drive. These embodiments then encrypt the stored password again after each hard drive initialization to authorize access to the hard drive. Further embodiments of the present invention utilize yet further storage protection, encryption, and security techniques to obscure and protect the security data that is required to authorize access to the hard drive.

The hard drive password generating process in this exemplary embodiment is transparent to the user and the hard drive password 132 is never made available to the user and remains inaccessible to the user. In other words, the password generation process is completely independent of a user. In one embodiment, only the BIOS 136 and the hard drive 118 retain representations of the hard drive password 132.

In another embodiment, the BIOS 136 receives an explicit instruction via a network 142, computer readable medium, or any other mechanism capable of passing an instruction to the BIOS 136 to generate a hard drive password 132. Also, the hard drive password generation process does not need to be performed during the manufacturing of the information processing system 100. For example, the BIOS 136 can be programmed to generate the hard drive password 132 at any point in time such as after a predefined number of hard drive initializations. In another embodiment the BIOS 136 receives an instruction to generate the hard drive password 132 but does not program the hard drive password 132 into the hard-drive until some later point in time. One example of when the hard drive password 132 is generated and/or programmed at a later time is a when used system is purchased for rental purposes. For example, a business that rents out computer systems acquires a used personal computer which has never been setup for hard drive password generation. In further embodiments, the BIOS 136 is incapable of generating the hard drive password 136. In such embodiments, another device, such as an external test fixture, generates the hard drive password 132.

Once the hard-drive 118 of the exemplary embodiment is programmed with the hard drive password 132 it is bound to the motherboard 102. In other words, the hard drive 118 only operates when coupled to the specific motherboard 102 that also contains the same the hard drive password 132. If the hard drive 118 is taken out of the information processing system 100 and inserted into another system (not shown), the hard drive 118 is inaccessible, e.g. does not allow read/write access to the drive, thereby deterring theft of components from a rental computer system.

Although the exemplary embodiments of the present invention are described in the context of a fully functional computer system, those skilled in the art will appreciate that embodiments are capable of being distributed as a program product via floppy disk, e.g. floppy disk 218, CD ROM, or other form of recordable media, or via any type of electronic transmission mechanism.

One advantage of the present invention is the automatic generation of a hard drive password. The hard drive password 132 is generated without any interaction by a user. The hard drive password 132 is never displayed to a user and is inaccessible to the user, thereby preventing the user from obtaining the hard drive password 132 and entering it into another information system. This prevents a user from overriding the security protection of the hard drive. Another advantage of the present invention is that the hard drive 118 is bound to the motherboard 102 that stores a representation of the hard drive password 132 in its firmware. Therefore, the data stored on the hard drive 118 is inaccessible if the hard drive 118 is coupled to another motherboard, thereby deterring theft of the hard drive 118.

Exemplary Process for Automatically Generating a Hard Drive Password

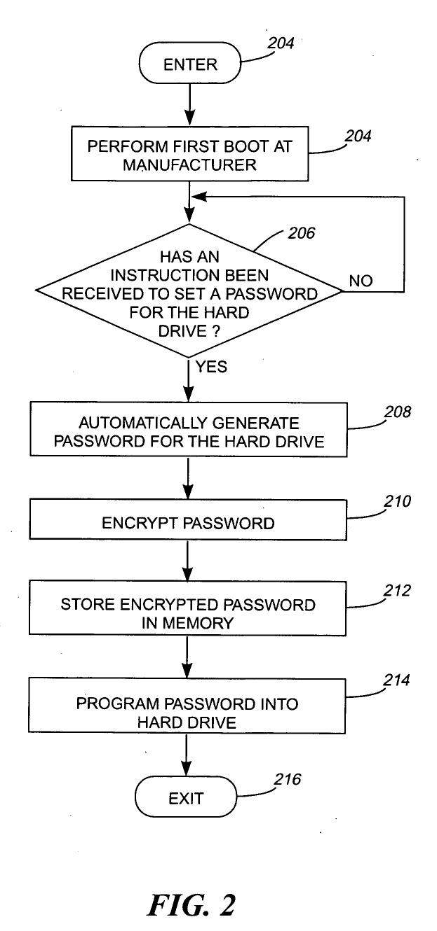

FIG. 2 illustrates an exemplary process of automatically generating a hard drive password 132 for binding a hard drive 118 to a motherboard 102. The operational flow diagram of FIG. 2 begins at step 202 and flows directly to step 204. The information processing system 100, at step 204, is booted for the first time at the manufacturer. The information processing system 100, at step 206, determines if an instruction has been received to set a password for the hard drive 118. For example, the BIOS 136 can be programmed to detect an instruction for setting a password 132. The instruction for setting a password 132 can be received via a network 142, a computer readable medium 120, user interface facilities such as a keyboard, and the like. In one embodiment, the BIOS 136 is programmed to detect a first boot and automatically set the password 132. If the result of this determination is negative, the information processing system 100 continues to monitor for an instruction to set a password 132. For example, the password does not necessarily have to be set at first boot. The password can be set at any point in time.

If the result of this determination is positive, a password, at step 208, is automatically generated by the information processing system 100. For example, the BIOS 136, in one embodiment, automatically generates the hard drive password 132 via the TPM 128. The hard drive password 132 generating process is transparent to a user and is performed independent of any user interaction without being accessible to the user. Also, the hard drive password 132, in one embodiment, is generated at a predefined point in time. For example, the generating process can be performed after a predefined number of system initializations, when a password binding instruction is received, and the like. It is advantageous to be able to selectively trigger password generation and information system to hard drive binding because not all information processing system are purchased directly from a manufacturer. For example, a used system can be purchased by a rental company that desires to bind the hard drive 118 to the system motherboard 102. This allows for the present invention to be implemented in currently existing systems.

The hard drive password 132, at step 210, is encrypted. For example, the TPM 128 includes one or more encrypting mechanisms that are used to encrypt the hard drive password 132. The encrypted hard drive password 132, at step 212, is stored in a non-volatile memory 134. The hard drive password, at step 214, is programmed into the hard drive 118. For example, the hard drive password 118 is programmed into the firmware of the hard drive 118. At this point, the hard drive 118 is bound to the motherboard 102 and is non-operational is with any other computer system since another computer system would not have the hard drive password to allow access to this hard drive 118. It should be noted that in other embodiments of the present invention, other system components are also bound to the motherboard 102 in a similar fashion. The control flow then exits at step 216.

Exemplary Process of Authenticating a Hard Drive

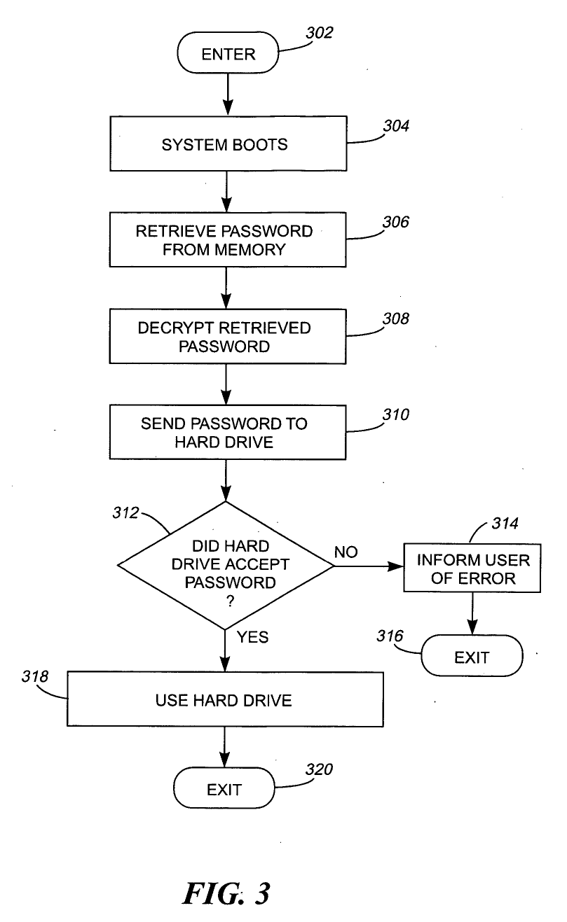

FIG. 3 illustrates an exemplary process of authenticating a hard drive 118 using a programmed hard drive password 132. The operational flow diagram of FIG. 3 begins at step 302 and flows directly to step 304. The information processing system 100, at step 304, boots. For example, the information processing system 100 powers-on, resets, or the like. The hard drive password 132, at step 306, is retrieved from the non-volatile memory 134. The hard drive password 132, in one embodiment, is retrieved after the hard drive 118 is initialized, which does not necessarily have to occur after a power-on or reset.

The retrieved hard drive password 132, at step 308, is decrypted. The retrieved hard drive password 132 is decrypted in the exemplary embodiment through the use of TPM 128. The decrypted hard drive password 132 is then sent, at step 310, to the hard drive 118. The information processing system 100 then determines, at step 312, if the hard drive accepted the password. For example, the hard drive 118 also has a copy of the hard drive password 132 and compares the hard drive password 132 received from the BIOS 136 to its own copy. If the result of this determination is negative, the user, at step 314, is informed of an error and the hard drive 118 is inaccessible. A negative result may also indicate that the hard drive 118 is lacking the password. For example, the original hard drive 118, which was bound to the motherboard 102, may have been taken out of the information processing system 100 and a new hard drive has been inserted. The new hard drive does not have the hard drive password 132 so the received password 132 from the BIOS 136 is rejected. As another example, the hard drive 118 has a different hard drive password than what the BIOS 136 had generated. Therefore, two hard drives password do not match and access to the hard drive is restricted. If the result of this determination at step 312 is positive, access, at step 318, is granted to the hard drive 118 so that it may be used. The control flow then exits at step 320.

### NON-LIMITING EXAMPLES

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. An automated method comprising:
automatically generating a set of security data;
storing the set of security data in non-volatile memory; and
programming the set of security data into the data storage device as a security code.

2. The method of claim 1, further comprising:
encrypting, prior to the storing, the set of security data, and wherein the non-volatile memory stores an encrypted set of security data.

3. The method of claim 1, wherein the storing stores the set of security data in one of an encrypted and an unencrypted state, the method further comprising:
initializing, after the programming the data storage device;
retrieving the set of security data from non-volatile memory, wherein the retrieving comprises one of decrypting, in response to storing the set of security data in an encrypted state, the security data, and encrypting, in response to storing the set of security data in a decrypted state, the security data; and
automatically transmitting, in response to the initializing, the set of security data to the data storage device.

4. The method of claim 1, wherein the automatically generating further comprises:
determining that the data storage device is lacking the set of security data.

5. The method of claim 1, wherein the set of security data is at least one of:
automatically generated at the first initialization of the data storage device;
automatically generated by a test fixture;
automatically generated after a predefined interval of time; and
automatically generated in response to receiving an instruction for securing the data storage device.

6. The method of claim 1, wherein the set of security data and the security code are inaccessible to a user.

7. The method of claim 1, wherein the set of security data is automatically generated independent of any user interaction.

8. An information processing system comprising:
a motherboard;
a security data generator, communicatively coupled to the motherboard, the security data generator automatically generating at least one set of security data; and
at least one data storage device, communicatively coupled to the motherboard, the data storage device requiring a programmed security code to access data stored therein,
wherein the security data generator programs, a security code associated with the set of security data into the at least one data storage device as a programmed security code.

9. The information processing system of claim 8, wherein the security data generator further comprises:
a basic input/output system for programming the security code into the data storage device as the programmed security code.

10. The information processing system of claim 9, wherein the basic input/output system:
initializes the data storage device;
retrieves the set of security data from non-volatile memory;
one of decrypts, in response to storing the set of security data in an encrypted state, the security data, and encrypts, in response to storing the set of security data in a decrypted state, the security data; and
automatically transmits the security code to the data storage device in response to initializing the data storage device.

11. The information processing system of claim 8, wherein the set of security data is a password.

12. The information processing system of claim 8, wherein the security data generator comprises a trusted platform module and further encrypts the set of security data.

13. The information processing system of claim 8, wherein the security data generator automatically generates the set of security data in response to at least one of:
a first initialization of the data storage device;
a predefined interval of time passing;
determining that the data storage device is lacking the set of security data; and
receiving an instruction for securing the data storage device.

14. The information processing system of claim 8, wherein the set of security data and the security code are inaccessible to a user.

15. A computer readable medium comprising instructions for:
automatically generating a set of security data;
storing the security data in non-volatile memory; and
programming the set of security data into the data storage device as a security code.

16. The computer readable medium of claim 15, further comprising instructions for:
encrypting, prior to the storing, the set of security data, and wherein the non-volatile memory stores an encrypted set of security data.

17. The computer readable medium of claim 15, further comprising instructions for:
initializing, after the programming the data storage device;
retrieving the set of security data from non-volatile memory, wherein the retrieving comprises one of decrypting, in response to storing the set of security data in an encrypted state, the security data, and encrypting, in response to storing the set of security data in a decrypted state, the security data; and
automatically transmitting, in response to the initializing, the set of security data to the data storage device.

18. The computer readable medium of claim 15, wherein the automatically generating further comprises instructions for:
determining that the data storage device is lacking the set of security data.

19. The computer readable medium of claim 15, wherein the set of security data is at least one of:
automatically generated at the first initialization of the data storage device;
automatically generated by a test fixture;
automatically generated after a predefined interval of time; and
automatically generated in response to receiving an instruction for securing the data storage device.

20. The computer readable medium of claim 15, wherein the set of security data and the security code are inaccessible to a user.
